(19) United States
(12) Patent Application Publication
(10) Pub. No.: US 2014/0239612 A1
(43) Pub. Date: Aug. 28, 2014

(54) Sound Generator for Spoked Wheel Vehicles

(71) Applicants: Joseph Middioine, Fresno, CA (US); Jacob Van Meter, Mariposa, CA (US)

(72) Inventors: Joseph Middioine, Fresno, CA (US); Jacob Van Meter, Mariposa, CA (US)

(21) Appl. No.: 13/775,181

(22) Filed: Feb. 23, 2013

(51) Int. Cl. B62J 3/00

(52) U.S. Cl. CPC B62J 3/00
USPC 280/288.4

(57) ABSTRACT

The present invention relates to sound generation for amusement purposes, and more particularly to sound generation devices for use with vehicles having wheels with spokes such as bicycles and tricycles. Embodiments of the invention include a base having a slot extending from one end part way down one side for receiving a sound generating card, the upper end of said slot being open to receive the card, and the lower end being closed to prevent the card from sliding out, the slot having an enlarged internal longitudinal area corresponding to a similar area on the card to prevent the card from being pulled through the slot as it makes sound through contact with the spokes of a wheel.

### BACKGROUND OF THE INVENTION

1. Field of the Invention

Generations of children have used a clothespin to attach a baseball or playing card to a wheel of a bicycle to generated an “engine” sound as the card contacts the spokes of the wheel.

Unfortunately, after even a small amount of use, the card would eventually wear out, or become bent or wet, such that it would no longer generate the desired sound. The constant need to replace used cards is a distraction from the overall enjoyment of the noise making produced by fresh cards. In addition, in many cases, the clothespin may not firmly grip the fork or wheel support. During use, an inadequate grip could allow the clothespin to slide relative to the support thereby moving the card away from the spokes such that no sound is generated.

2. Description of the Prior Art

Over the years, different attempts have been made to create sound generators for spoked wheel vehicles. One apparatus includes a flap portion that is inserted into the spokes to generate the engine sound, and an attachment mechanism having a cylindrical interior having a gap along one side. The gap allows the cylindrical portion to clip over a rounded bicycle fork. However, such devices are limited to use with bicycles and other vehicles having rounded forks, and may not provide a firm grip especially on forks having other cross-sectional shapes (e.g. oval). Attaching and detaching the clip may also damage the paint on the fork.

A different sound maker for use on a bicycle is disclosed in U.S. Patent D644550 which illustrates a one-piece unit having two flaps that extend out tangentially from a partially cylindrical interior mounting area, and related tabs for opening/closing the interior area. However, this sound maker is also designed for use with cylindrical forks, and the large gap may not firmly grip the fork allowing the flaps to move away from the spokes during use, stopping the generation of sound.

Another sound generating apparatus disclosed in U.S. Pat. No. 7,694,488 comprises a thin, deformable plastic piece that is wrapped around an attachment location such as a bicycle fork leaving a free end that protrudes into the spokes of the adjacent wheel for noise generation, the plastic piece being secured to the fork using a fastener. However, the free end of the plastic piece is easily moved and therefore may not always extend fully into the spokes. In addition, the free end may be broken after use, requiring replacement of the entire assembly instead of simply swapping for a new card.

It is therefore desirable to provide a sound-generating device for use with a wide variety of spoked-wheel vehicles that is durable so that it lasts longer between replacements, reliable so that it tends to stay engaged with the spokes, and easily repaired or made functional in the event of a failure.

### SUMMARY OF THE INVENTION

The present invention includes methods and apparatus for generating sounds using the spokes of a wide variety of vehicles by providing sound-generating devices that are durable, reliable, and easily repaired or replaced. Embodiments of the invention include a base member for engagement with a fork or support for a wheel of a spoked vehicle, and a separate card or flap that is engaged with the base member. The base is preferably made of sturdy, rigid material. The card may be made of the same material as the base, but with a thinner cross-section in order to deform slightly and flap between the spokes of a wheel; or the card may be made of less rigid material. It is to be appreciated that the rigidity of the card will depend on the loudness of the sound desired to be generated by the card in the spokes, that such sound may be increased by using a more rigid material, or decreased by using a more flexible material.

In embodiments of the invention, the base member is elongated, and in some embodiments an elongated side of the base member may be specially shaped or contoured to conform to the shape of the edge of the fork or wheel support to which the base will be engaged. It is to be appreciated that the shaping of this side may be different in different embodiments in accordance with the shape of the fork/wheel support to which it is to be attached in order to provide a more snug fit. For example, and without limitation, this side may have a concave shape (that may be varied in arc) to accept a rounded or oval fork, or the side may have one or more angles or corners to receive corresponding corner(s) of a triangular, square, hexagonal, octagonal or other shaped fork, etc.

Embodiments of the invention provide a specially-shaped slot on the base member for receiving a corresponding edge of the card to hold the card securely in place. In embodiments of the invention, the slot extends partway along an elongated side of the base member, on a side that is different from the optionally contoured side, the slot being open at one end of the base (to receive an edge of card), but closed at the opposite end (to prevent the card from dropping out of the slot). In some embodiments of the invention, one or more holes are provided through the base member for receiving attachment devices to secure the base member to a vehicle fork or wheel support. It is to be appreciated that alternative embodiments may include different combinations or permutations of the features disclosed herein.

In use, one of the elongated sides of a base member of an embodiment of the invention may be formed or contoured to conform to the shape of the vehicle fork to which it will be engaged. An elongated side of the base is engaged to a vehicle fork or wheel support, preferably with such contoured side against the fork, using one or more attachment devices that are wrapped around the fork, and passed through the one or more holes in the base. For example and without limitation, the engagement devices may be nylon straps, or ties with one-way tightening mechanisms. This allows the base to be securely attached to the vehicle fork without slipping out of place during use. The base is mounted on the fork such that a side having a vertical slot therein is generally vertically oriented, and faces toward the spokes of the wheel, with the open end of the slot at the top, and the closed end at the bottom. The slot is formed such that it has an elongated narrow opening or slit along the side of the base, but a wider interior area to receive an enlarged edge of a card.

A card having an enlarged edge is placed into the slot by inserting the enlarged edge of the card into the (upper) end opening on the base, and sliding the card (down) into the slot. The closed end of the slot (at the bottom) prevents the card from falling out of the slot, thereby retaining the card in the slot. By inserting the card into the slot in this manner, the body of the card extends into the spoke area of the wheel where it can make contact with the spokes as the wheel turns, generating the desired sound. It is to be appreciated that the enlarged interior area of the slot should closely match the enlarged edge of the card so as to provide a snug and secure engagement between card and slot. This allows the card to resist the lateral forces imparted by the spokes of the wheel without becoming dislodged, thereby creating the desired sound, while also making it possible to easily remove and replace the card by sliding it longitudinally through the (top) end opening of the slot.

It is to be appreciated that cards having different shapes may be used with a base of the present invention, so long as such cards have at least one edge having a shape that conforms to the shape of the receiving slot in the base. It is also to be appreciated that cards may be provided in different colors, and/or with different logos, advertising, or other graphic displays. It is therefore an object of the present invention to provide a noise making device for use with a wheel with spokes, the device having a removable base for attachment adjacent to a wheel with spokes, the base having a narrow slot extending part way down one side for receiving a removable card to be inserted into said spokes to generate noise, the slot being open at the top but closed at the bottom of the base to prevent the card from falling out, the slot and card both having corresponding enlarged areas for preventing the card from being pulled through the slot during use.

It is also an object of the present invention to provide methods of generating noise from wheels having spokes using a slotted base and corresponding removable cards as described herein.

Additional objects of the invention will be apparent from the detailed descriptions and the claims herein.

### BRIEF DESCRIPTION OF THE DRAWINGS

The invention is further illustrated by the following drawings.

FIG. 1 is a front perspective view of an embodiment of a base of the present invention.

FIG. 2 is a different front perspective view of an embodiment of a base of the present invention.

FIG. 3 is a side elevational view of a base and card of an embodiment of the present invention.

FIG. 4 is a side elevational view of an embodiment of a card of the present invention.

FIG. 5 is a top view of an embodiment of a card of the present invention.

FIG. 6 is a perspective view of an embodiment of a card of the present invention.

FIG. 7 is an end elevational view of an embodiment of a card of the present invention.

FIG. 8 is a perspective view of an embodiment of a card inserted into an embodiment of a base of the present invention.

FIG. 8A is a perspective view of an embodiment of a card inserted into an embodiment of a base of the present invention.

FIG. 9 is a side elevational view of an embodiment of a card inserted into an embodiment of a base of the present invention.

FIG. 10 is a side elevational view of an embodiment of the present invention showing how a card fits into a slot in a base.

FIG. 11 is a perspective view of the embodiment of FIG. 10.

FIG. 12 is a side view of an embodiment of the invention installed on a bicycle.

FIG. 13 is an end view of the embodiment of FIG. 12.

FIG. 14 is a set of views of an alternative embodiment of the present invention.

### DETAILED DESCRIPTION

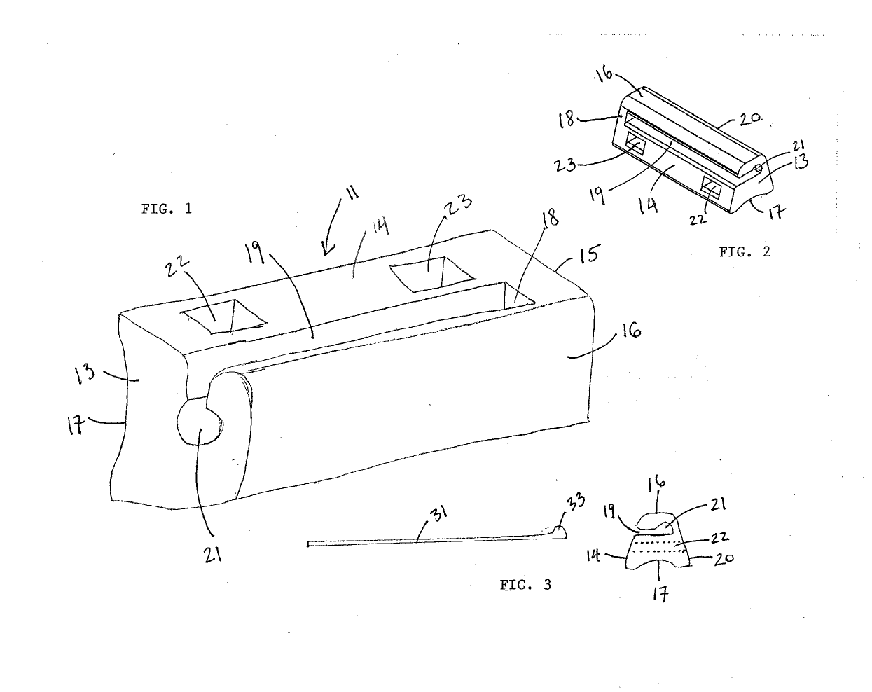

Referring to the drawings wherein like reference characters refer to the same or equivalent structure throughout the several views, and referring particularly to FIGS. 1-3 and 14, it is seen that the illustrated embodiments of the invention include a base 11 having an elongated shape with opposite ends 13 and 15. One side 17 of base 11 may preferably be contoured in order to conform to a wheel support or fork, as shown in FIGS. 1 and 2. An elongated slot 19 is provided part way along a side 14 of base 11. Slot 19 is open along much of side 14, and is also open at the (top) end 13 of base 11. However slot 19 is closed at the opposite (bottom) end 15 of base 11 at 18. An elongated, enlarged area 21 is provided inside slot 19 for receiving a similarly-shaped edge 33 of a card 31. One or more openings 22, 23 are provided in base 11 for receiving attachment devices to hold base 11 against a support 37 for a wheel 38 having spokes 39. Openings 22, 23 extend completely through base 11, from a proximal side 14 to distal side 20. In the alternative embodiment of FIG. 14, an opening 24 is provided in side 17.

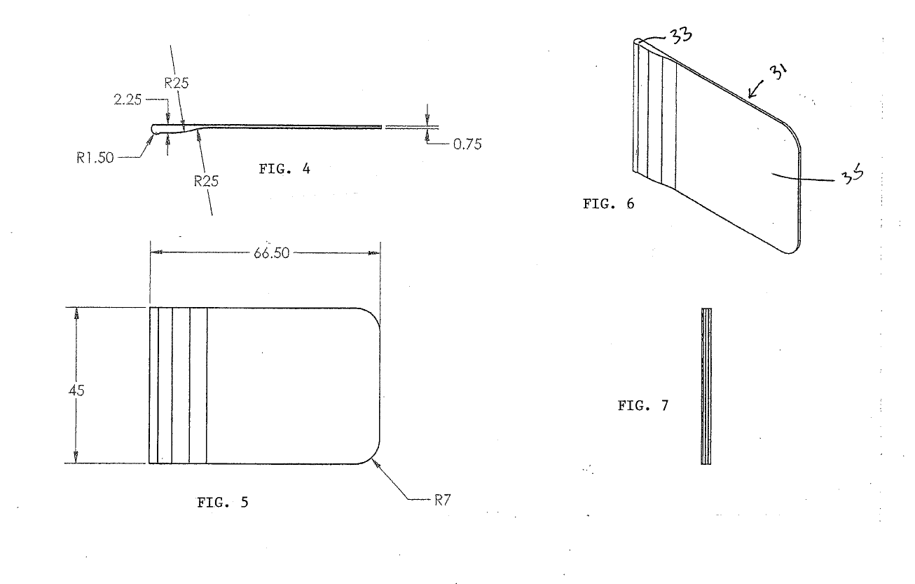

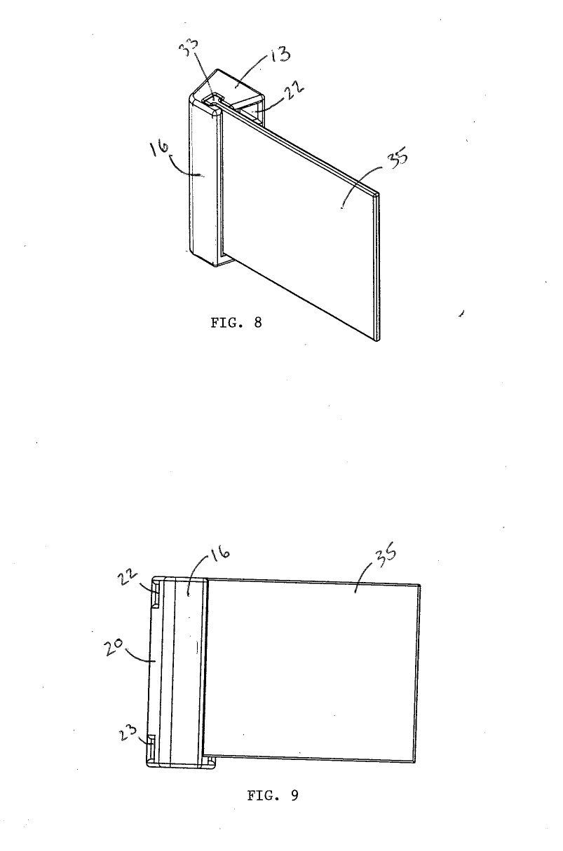

A separate removable card 31 is provided for insertion into slot 19. An edge 33 of card 31 is enlarged to correspond to the enlarged area 21 in slot 19. Although enlarged area 21 is illustrated as being having a rounded cross section, it is to be appreciated that the enlarged area 21 and corresponding card edge 33 may be of any suitable shape including without limitation rounded, oval, triangular, square, rectangular, diamond, trapezoidal, rectangular, hexagonal, octagonal, T-shaped (see FIG. 8A), and the like, so long as edge 33 and area 21 have the same shape, or at least a complementary shape, for snug engagement. For example and without limiting the claims herein, card 31 may have a thickness of 0.75 mm, and edge 33 and enlarged area 21 may have a thickness of 2.25 mm (the rounded area having a radius of 1.5 mm), as shown in FIG. 4. For example and without limiting the claims herein, card 31 may have a height of 45 mm and a width of 66.5 mm, as illustrated in FIG. 5. It is to be appreciated that edge 33 and enlarged area 21 may be of any suitable size, so long as that size is larger than the thickness of card 33 and slot 19; and that the thickness, height and width of card 33 may be varied over broad ranges.

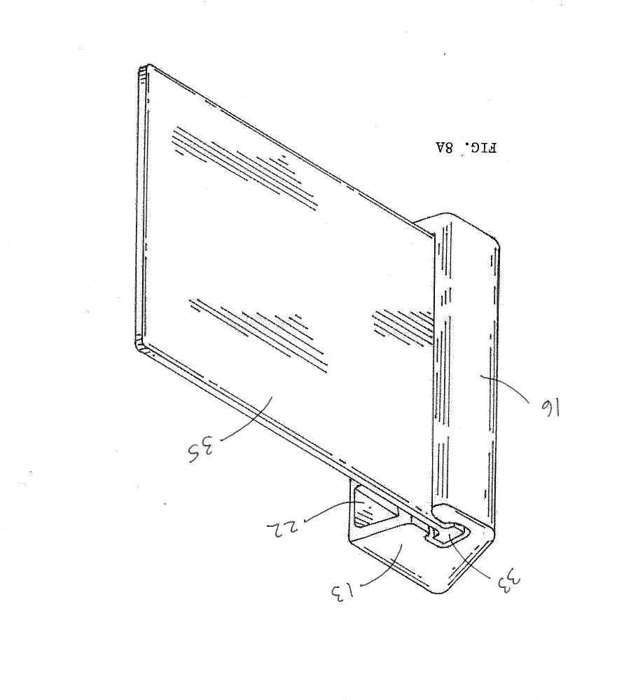

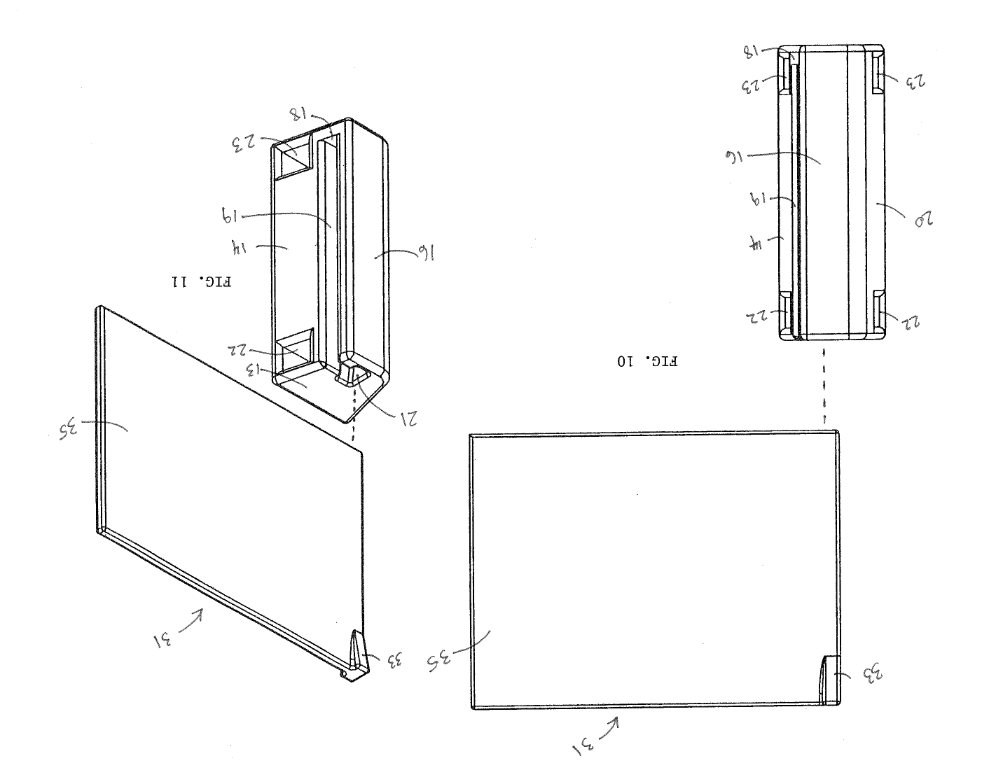

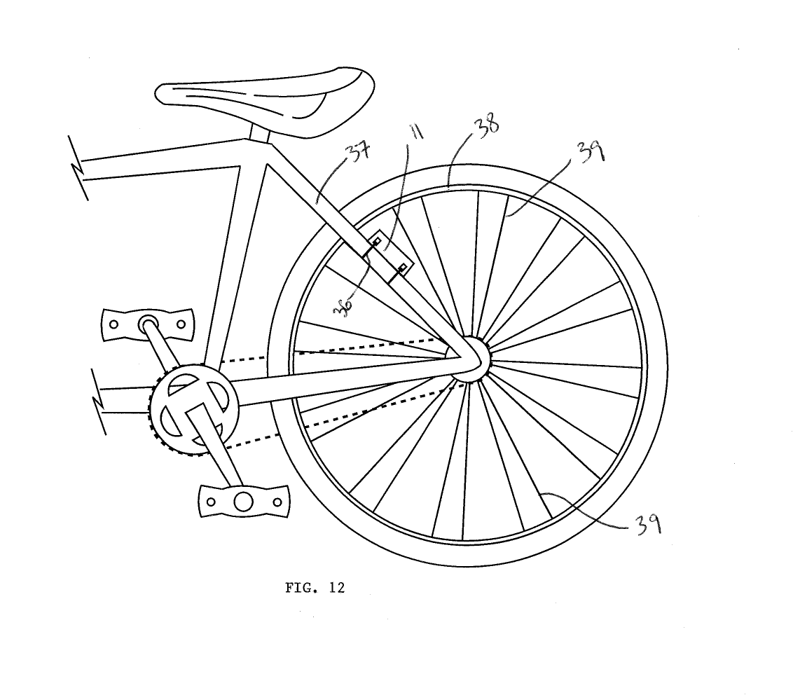

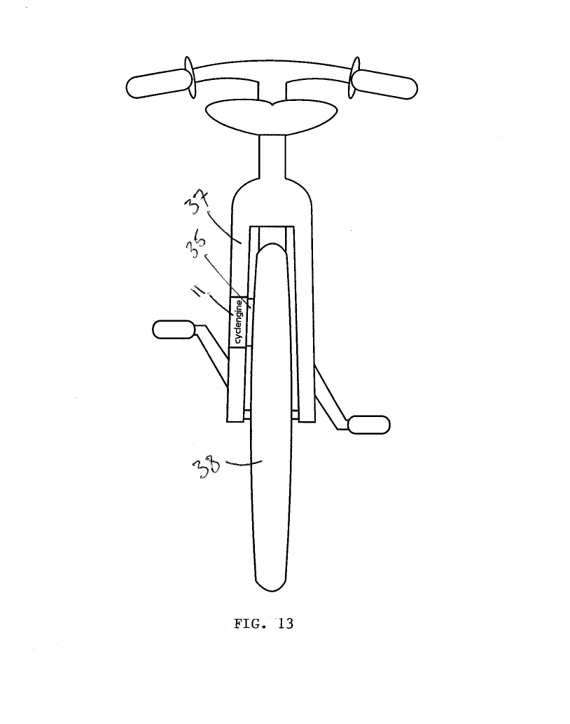

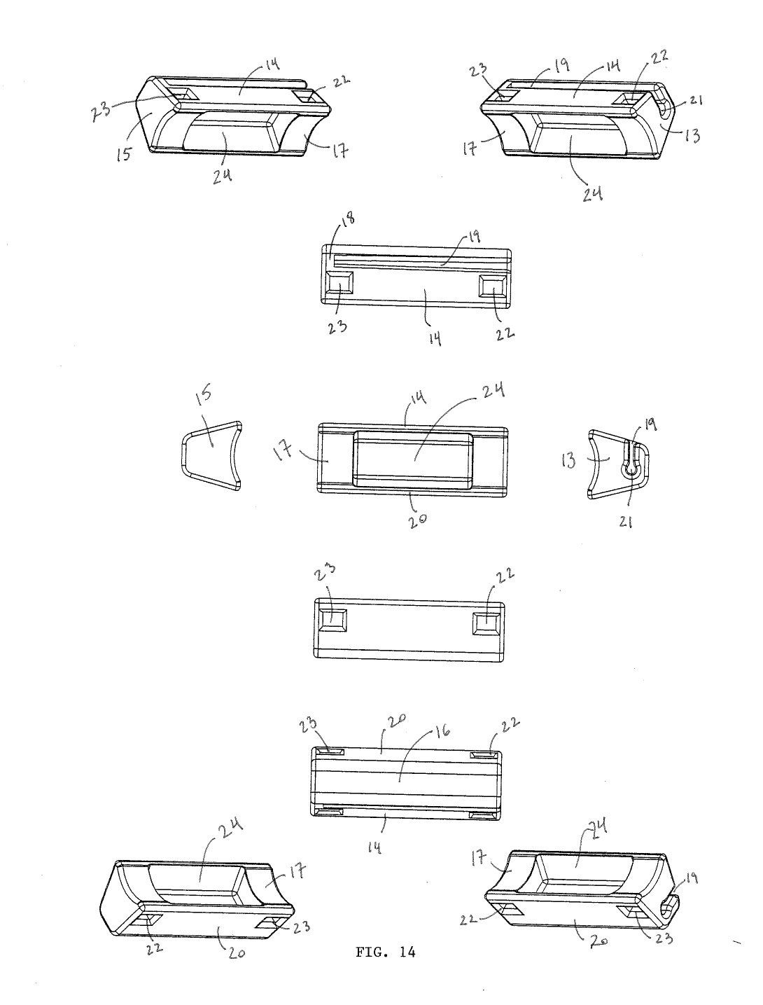

Card 31 may be inserted into slot 19 by aligning the enlarged edge 33 of card 31 with the enlarged area 21 of the slot opening at the end 13 of base 11. Edge 33 slides into enlarged area 21 such that the body 35 of the card 31 protrudes out from the slot 19 as shown in FIGS. 8 and 9 (and thereafter into the spokes 39 of a wheel 38, as shown in FIG. 13). Area 18 at the opposite end 15 of base 11 prevents card 31 from sliding out of slot 19. The corresponding enlarged areas 21 and 33 of slot 19 and card 31, respectively, prevent card 31 from being pulled through the elongated portion of slot 19 located on side 14, preventing lateral dislodgement when card 31 contacts the spokes 39 of the wheel 38. However, card 31 may be easily removed by sliding it longitudinally through the opening in end 13 of base 19. A replacement card 31a may be easily inserted by aligning it as above, and using an inserting sliding force.

In an alternative embodiment illustrated in FIGS. 10 and 11, the enlarged area 33 of card 31 does not extend along an entire edge of the card, but is provided at one end thereof. As with other embodiments, the enlarged area 33 of card 31 fits into the enlarged area 21 of slot 19 as to prevent dislodgement, as shown in FIG. 8A. As with other embodiments, card 31 may be easily removed by sliding it longitudinally through the opening in end 13 of base 19. A replacement card 31 a may be easily inserted by aligning it as above, and using an inserting sliding force.

It is to be appreciated that in other embodiments, other forms of enlargement of some or all of a side edge of card 31 may be provided so long as the enlarged portion of the edge of card 31 corresponds to an enlarged area 21 of slot 19 to prevent the card 31 from being pulled through slot 19 while in use.

To install the illustrated embodiment of the invention, a base 11 which may have a desired contoured edge 17 is placed against vehicle wheel support 37, with slot 19 facing the spokes 39 of the wheel 38, and the open end 13 of slot 19 facing upwardly. One or more attachment straps 36 (such as, without limitation, nylon or other ties which may have one-way tightening mechanisms) are inserted through openings 22, 23 and around support 37, and tightened to hold base 11 firmly against support 37, as shown in FIG. 12.

A card 31 may then be aligned with the opening of slot 19 in the end 13 of base 11 such that an enlarged area 33 on an edge of card 31 aligns with a corresponding enlarged area 21 in slot 19. The card 31 is then inserted into slot 19 by downwardly sliding enlarged edge 33 into corresponding area 21. The bottom 18 of slot 19 prevents the card 31 from exiting slot 19 through the bottom, and the narrow portion of slot 19 prevents the enlarged edge 33 of card 31 from being pulled out through slot 19 by the action of the spokes 39 against the card 31. The body 35 of the card protrudes into the spokes 39 of the wheel 38 as shown in FIG. 13, allowing a sound to be generated as the spokes encounter the card as the wheel turns. The card 31 may be easily removed by pulling it upward through the opening in end 13 of base 11. A replacement card 31 a may be easily inserted in the same manner as above, by aligning the enlarged edge of the card with the enlarged opening in the slot, and sliding the card into the slot. Cards 31, 31a may be provided in different thicknesses and/or lengths in order to provide different resistance to spokes 39 thereby generating different sounds. Cards 31, 31a may also be provided in different shapes, such as, without limitation, square, rectangular, triangular, hexagonal, polyagonal, and the like so long as each card has at least one elongated side having the enlarged area 33 for insertion into slot 19 and opening 21. Cards 31, 31a may be provided in different colors which may be used, for example, to match or coordinate with the color of the vehicle with which the card is used, to indicate the thickness or length of the card, etc. Cards 31, 31a may also be used to display advertising, slogans, logos, insignias, or other messages. Such displays may be etched or molded into the cards, or affixed thereto using such things as stickers, paint and/or decals.

It is to be understood that variations, permutations, and modifications of the present invention may be made without departing from the scope thereof. One or more features of an exemplary embodiment as described above may be practiced in conjunction with other exemplary embodiments as described above. It is also to be understood that the present invention is not to be limited by the specific embodiments disclosed herein, but only in accordance with the appended claims when read in light of the foregoing specification.

1. A sound generator for a wheel with spokes comprising:
a. an elongated one-piece base having a concavity on a first side thereof for engaging with a convex portion of a member adjacent to a wheel of a vehicle, the base having a second side with a slot extending part way along said second side thereof, said slot being open at one end of said base and closed at an opposite end thereof, said slot having an enlarged longitudinal internal area therein;
b. at least one opening extending through said base from a proximal side to a distal side thereof for receiving at least one strap to attach said base to said member adjacent to said wheel of said vehicle; and
c. a removable card having a body and at least one edge, said edge having an enlarged area thereon corresponding to the enlarged longitudinal internal area of said slot for insertion into said slot such that said body extends out from said slot.

2. The sound generator of claim 1 wherein a pair of openings are provided through said base, and further comprising a pair of straps for attaching said base to said member.

3. The sound generator of claim 1 wherein the body of said card has a rectangular shape.

4. The sound generator of claim 1 wherein the body of said card has a triangular shape.

5. The sound generator of claim 1 wherein the enlarged longitudinal area of said slot and the enlarged area of said card have a rounded cross sectional shape.

6. The sound generator of claim 1 wherein the enlarged longitudinal area of said slot and the enlarged area of said card have a T shape.

7. The sound generator of claim 1 wherein the enlarged area of said card extends along an entire longitudinal edge of said card.

8. A noise making device for use with a wheel having spokes comprising:
a. an elongated one-piece base member having a plurality of sides, a first end and an opposite second end wherein one of said sides includes a concavity for engaging against a convex portion of a wheel support member;
b. an elongated slot extending from the first end of said elongated base member part way along a first side of said member, said slot having a narrow opening along said side, and having an enlarged internal longitudinal area having a larger cross section than said narrow opening, said enlarged cross section and opening extending to said first end, wherein the opposite end of said elongated base member is closed;
c. at least one separate opening in said base member extending therethrough from said first side to another side;
d. at least one strap for insertion through said at least one separate opening for attaching said base member to said wheel support member; and
e. a removable card having an edge said edge having an enlarged area corresponding to said enlarged area of said slot.

9. The noise making device of claim 8 wherein said card has a body with a rectangular shape.

10. The noise making device of claim 8 wherein said card has a body with a triangular shape.

11. The noise making device of claim 8 wherein the enlarged longitudinal area of said slot and the enlarged area of said card have a rounded cross sectional shape.

12. The noise making device of claim 8 wherein the enlarged longitudinal area of said slot and the enlarged area of said card have T shape.

13. The sound generator of claim 8 wherein the enlarged area of said card extends along an entire longitudinal edge of said card.

14. A method of generating noise with the spokes of a wheel comprising the steps of:
a. Attaching a base to a support for a wheel having spokes using at least one strap that is passed through at least one opening extending through said base;
b. Aligning said base such that a slot extending partway along a side thereof faces the spokes of said wheel;
c. Inserting a card having an edge with an enlarged cross sectional area into a corresponding slot in said base, said slot having a corresponding enlarged longitudinal cross section, said slot extending from an upper end of said base along a side thereof but not reaching an opposite end of said base, said opposite end being closed, such that said card extends into the spokes of said wheel; and
d. Turning said wheel such that said spokes come into contact with said card generating a noise from said contact.

15. The method of claim 14 comprising the additional step of removing said card from said slot by sliding said card upwardly through said upper end, and inserting a different card into said slot.
